(19) United States
(12) Patent Application Publication
(10) Pub. No.: US 2025/0196365 A1
(43) Pub. Date: Jun. 19, 2025

(54) CONTROL OF A SPRAY PAINTING ROBOT WITH A PAINTING TRAJECTORY OPTIMIZED FOR ENERGY CONSUMPTION AND PROCESS TIME

(71) Applicant: CHERKAM LTD., Peterborough (CA)

(72) Inventors: Hossam GABER, North York (CA); Muhammad IDREES, Oshawa (CA)

(21) Appl. No.: 18/586,083

(22) Filed: Feb. 23, 2024

Related U.S. Application Data
(60) Provisional application No. 63/610,172, filed on Dec. 14, 2023.

(51) Int. Cl. B25J 11/00; B25J 9/16; B25J 19/02

(52) U.S. Cl. CPC B25J 11/0075; B25J 9/161; B25J 9/1661; B25J 19/023

(57) ABSTRACT

A system, and a related method and a related computer-program product are provided for controlling a 3D scanner and a painting robot to spray paint an object having an object surface are provided. The painting robot has an end effector adapted to hold or comprising a paint spray gun. The system includes a processor and a memory that stores instructions executable the processor to: control the 3D scanner to scan the object to generate the point cloud model of the object surface; based on the point cloud model of the object surface, determine an optimized painting trajectory defined by slices of the point cloud model; and based on the optimized painting trajectory, control actuation of the painting robot to paint the object surface. Determining the optimized painting trajectory comprises applying an optimization algorithm to minimize a cost function defined by an energy consumption cost and/or a process time cost.

### CROSS-REFERENCE TO RELATED APPLICATION

This application claims priority to and the benefit of U.S. provisional application No. 63/610,172 filed on Dec. 14, 2023, the entire contents of which are hereby incorporated by reference herein.

### FIELD OF THE DISCLOSURE

The present disclosure relates to systems, methods, and computer program products for automated control of a spray painting robot.

### BACKGROUND OF THE DISCLOSURE

Mass produced objects (e.g., vehicle parts) having standardized surface geometries may be painted using robotic arms that move a paint spray gun in a trajectory defined by pre-programmed software instructions or a computer aided design (CAD) model. Defining the trajectory for a complex surface geometry is non-trivial and impractical to perform for objects to be painted in low volumes or having variable surface geometries.

Chinese patent no. 106853433B (2020-03-20; Xu et al.), titled “Intelligent automobile paint spraying method based on cloud computing” discloses an automobile paint spraying method that involves scanning an automobile part to generate point cloud data, preprocessing the point cloud data to generate a three-dimensional digital model, generating a point cloud slice by inputting a slice direction and slice level by a user, determining the position and orientation of a paint spray gun based on the point cloud slice, and optimizing the speed and interval of the spray gun based on the point cloud data to achieve a desired painting quality in terms of coating thickness and consistency thereof.

There remains a need in the art for automated or semi-automated systems and methods for controlling a painting robot to spray paint an object that optimizes the painting trajectory for considerations other than painting quality, such as the energy consumption and process time required by the painting robot to paint the object.

### SUMMARY OF THE DISCLOSURE

In one aspect, the present disclosure comprises a system for controlling a 3D scanner and a painting robot to spray paint an object. The painting robot comprises an end effector adapted to hold or comprising a paint spray gun. The system comprises a controller. The controller comprises a processor operatively connected to the 3D scanner and the painting robot. The controller also comprises a memory comprising a non-transitory computer readable medium storing instructions executable by the processor to implement a method. The method comprises: controlling the 3D scanner to scan the object to generate the point cloud model of the object surface. The method comprises: based on the point cloud model of the object surface, determining an optimized painting trajectory defined by slices of the point cloud model. Each of the slices is defined by a slice angle, a slice width, and a slice speed. Determining the optimized painting trajectory comprises applying an optimization algorithm to minimize a cost function defined by at least one cost parameter comprising at least one of: an energy consumption cost based on a calculated amount of energy required for the painting robot to move the end effector along the slices; and a process time cost based on a calculated amount of time required for the painting robot to move the end effector along the slices. The method comprises: based on the optimized painting trajectory, controlling actuation of the painting robot to paint the object surface.

In another aspect, the present disclosure comprises a method for controlling a 3D scanner and a painting robot to spray paint an object comprising an object surface. The painting robot comprises an end effector adapted to hold or comprising a paint spray gun. The method is implemented by a processor operatively connected to the 3D scanner and the painting robot. The method comprises: controlling the 3D scanner to scan the object to generate the point cloud model of the object surface. The method comprises: based on the point cloud model of the object surface, determining an optimized painting trajectory defined by slices of the point cloud model. Each of the slices is defined by a slice angle, a slice width, and a slice speed. Determining the optimized painting trajectory comprises applying an optimization algorithm to minimize a cost function defined by at least one cost parameter comprising at least one of: an energy consumption cost based on a calculated amount of energy required for the painting robot to move the end effector along the slices; and a process time cost based on a calculated amount of time required for the painting robot to move the end effector along the slices. The method comprises: based on the optimized painting trajectory, controlling actuation of the painting robot to paint the object surface.

In another aspect, the present disclosure comprises a computer program product comprising a non-transitory computer readable medium storing instructions executable by a processor to implement a method for controlling a 3D scanner and a painting robot to spray paint an object comprising an object surface. The processor is operatively connected to a 3D scanner and the painting robot. The painting robot comprises an end effector adapted to hold or comprising a paint spray gun. The method comprises: controlling the 3D scanner to scan the object to generate the point cloud model of the object surface. The method comprises: based on the point cloud model of the object surface, determining an optimized painting trajectory defined by slices of the point cloud model. Each of the slices is defined by a slice angle, a slice width, and a slice speed. Determining the optimized painting trajectory comprises applying an optimization algorithm to minimize a cost function defined by at least one cost parameter comprising at least one of: an energy consumption cost based on a calculated amount of energy required for the painting robot to move the end effector along the slices; and a process time cost based on a calculated amount of time required for the painting robot to move the end effector along the slices. The method comprises: based on the optimized painting trajectory, controlling actuation of the painting robot to paint the object surface.

In embodiments of the system of the present disclosure, the system may further comprise the 3D scanner.

In embodiments of the system of the present disclosure, the system may further comprise the painting robot.

In embodiments of the system, the method, and the computer program product of the present disclosure, the at least one cost parameter may comprise both the energy consumption cost and the process time cost.

In embodiments of the system, the method, and the computer program product of the present disclosure, the at least one cost parameter may further comprise a paint coating thickness deviation cost based on a difference between a paint coating thickness calculated based on the slices and a pre-defined desired paint coating thickness.

In embodiments of the system, the method, and the computer program product of the present disclosure, the at least one cost parameter may further comprise a paint coating thickness variability cost based on a standard deviation of a paint coating thickness calculated based on the slices.

In embodiments of the system, the method, and the computer program product of the present disclosure, the at least one cost parameter may comprise a plurality of cost parameters, wherein the cost function is further defined by a plurality of weighting factors, wherein each one of the weighting factors is applied to a respective one of the cost parameters. In embodiments of the system, the method, and the computer program product of the present disclosure, the method further comprises displaying, on a display device, a graphical user interface allowing for user input of the weighting factors.

In embodiments of the system, the method, and the computer program product of the present disclosure, the optimization algorithm may comprise a genetic algorithm.

In embodiments of the system, the method, and the computer program product of the present disclosure, the slices of the optimized painting trajectory may have equal widths.

In embodiments of the system, the method, and the computer program product of the present disclosure, the slices of the optimized painting trajectory may have unequal widths. In embodiments, the painting robot may comprise a plurality of painting robots.

### BRIEF DESCRIPTION OF THE DRAWINGS

For a better understanding of the various embodiments described herein and to show more clearly how they may be carried into effect, reference will now be made, by way of example only, to the accompanying drawings in which:

FIG. 1 is a front left perspective view of a system of the present disclosure being used to spray paint a car door;

FIG. 2 is a rear right perspective view of the system of FIG. 1;

FIG. 3 is a front left perspective view of the system of FIG. 1;

FIG. 4 is a top plan view of the system of FIG. 1;

FIG. 5 is a perspective view of a scanner subassembly of the system of FIG. 1;

FIG. 6 is a perspective view of part of an object actuator subassembly of the system of FIG. 1, when attached to a car door;

FIG. 7 is a perspective view of an enclosure containing electronic components of the system of FIG. 1;

FIG. 8 is a functional block diagram of some components of the system of FIG. 1;

FIG. 9 is a flow chart of an embodiment of a method of the present disclosure for controlling a painting robot, as implemented by the system of FIG. 1;

FIG. 10 is an embodiment of a graphical user interface for a user to enter or select parameters governing the method of FIG. 9;

FIG. 11 shows a geometric model for a paint spray cone emitted by a paint spray gun, used in an embodiment of the method of FIG. 9;

FIG. 12 shows a model for static paint coating deposition on an object surface, used in an embodiment of the method of FIG. 9;

FIG. 13 shows a model for distribution of paint coating thickness, used in an embodiment of the method of FIG. 9;

FIG. 14 shows a model for a painting robot, used in an embodiment of the method of FIG. 9;

FIG. 15 shows a model for a paint spraying process, used in an embodiment of the method of FIG. 9;

FIG. 16 shows a model for paint spray gun strokes including overlap regions and trajectory points, used in an embodiment of the method of FIG. 9;

FIG. 17 is a flow chart of an embodiment of an optimization algorithm used in the method of FIG. 9;

FIGS. 18A to 18D are graphical representations of exemplary optimized painting trajectories determined by the system and method of the present disclosure for painting a car door based on: equidistant point cloud slicing at a slice angle of 0° (FIG. 18A); non-equidistant point cloud sliding at a slice angle of 0° (FIG. 18B); equidistant point cloud slicing at a slice angle of 90° (FIG. 18C); and non-equidistant point cloud slicing at a slice angle of 90° (FIG. 18D);

FIGS. 19A to 20B are charts showing the effect of different point cloud slice angles for both equidistant point cloud slicing and non-equidistant point cloud slicing on the following costs: total energy consumption (FIG. 19A); total process time; paint coating thickness deviation cost (FIG. 20A); and paint coating thickness variability cost (FIG. 20B).

### DETAILED DESCRIPTION OF EMBODIMENTS OF THE DISCLOSURE

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise explained, all technical and scientific terms used herein have the same meaning as commonly understood by one of ordinary skill in the art to which this disclosure belongs.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”. The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. It will be understood that any embodiments described as “comprising” certain components may also “consist of” or “consist essentially of” these components, wherein “consisting of” has a closed-ended or restrictive meaning and “consisting essentially of” means including the components specified but excluding other components except for components added for a purpose other than achieving the technical effects described herein.

It will be understood that any component defined herein as being included may be explicitly excluded from the claimed invention by way of proviso or negative limitation, such as any specific component or method steps, whether implicitly or explicitly defined herein.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.”

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

As used in this document, “attached” in describing the relationship between two connected parts includes the case in which the two connected parts are “directly attached” with the two connected parts being in contact with each other, and the case in which the connected parts are “indirectly attached” and not in contact with each other, but connected by one or more intervening other part(s) between.

“Memory” refers to a non-transitory tangible computer-readable medium for storing information (e.g., data or data structures) in a format readable by a processor, and/or instructions (e.g., computer code or software programs or modules) that are readable and executable by a processor to implement an algorithm. The term “memory” includes a single device or a plurality of physically discrete, operatively connected devices despite use of the term in the singular. Non-limiting types of memory include solid-state semiconductor, optical, magnetic, and magneto-optical computer readable media. Examples of memory technologies include optical discs such as compact discs (CD-ROMs) and digital versatile discs (DVDs), magnetic media such as floppy disks, magnetic tapes or cassettes, and solid state semiconductor random access memory (RAM) devices, read-only memory (ROM) devices, electrically erasable programmable read-only memory (EEPROM) devices, flash memory devices, memory chips and combinations of the foregoing. Memory may be non-volatile or volatile. Memory may be physically attached to a processor, or remote from a processor. Memory may be removable or non-removable from a system including a processor. Memory may be operatively connected to a processor in such as way as to be accessible by a processor. Instructions stored by a memory may be based on a plurality of programming and/or markup languages known in the art, with non-limiting examples including the C, C++, C#, Python™, MATLAB™, Java™, JavaScript™, Perl™, PHP™, SQL™, Visual Basic™, Hypertext Markup Language (HTML), Extensible Markup Language (XML), and combinations of the foregoing. Instructions stored by a memory may also be implemented by configuration settings for a fixed-function device, gate array or programmable logic device.

“Processor” refers to one or more electronic hardware devices that is/are capable of reading and executing instructions stored on a memory to perform operations on data, which may be stored on a memory or provided in a data signal. The term “processor” includes a single device or a plurality of physically discrete, operatively connected devices despite use of the term in the singular. The plurality of processors may be arrayed or distributed. Non-limiting examples of processors include integrated circuit semiconductor devices and/or processing circuit devices referred to as computers, servers or terminals having single or multi processor architectures, microprocessors, microcontrollers, microcontroller units (MCU), central processing units (CPU), field-programmable gate arrays (FPGA), application specific circuits (ASIC), digital signal processors, programmable logic controllers (PLC), and combinations of the foregoing.

Any method, application or module herein described may be implemented using computer readable/executable instructions that may be stored or otherwise held by a memory, and executed by a processor. Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments of the inventions described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

### System Overview.

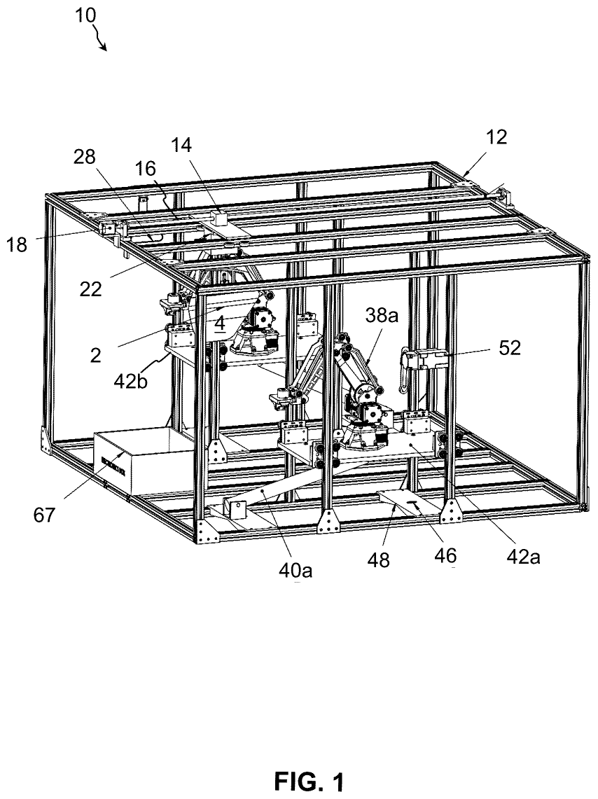

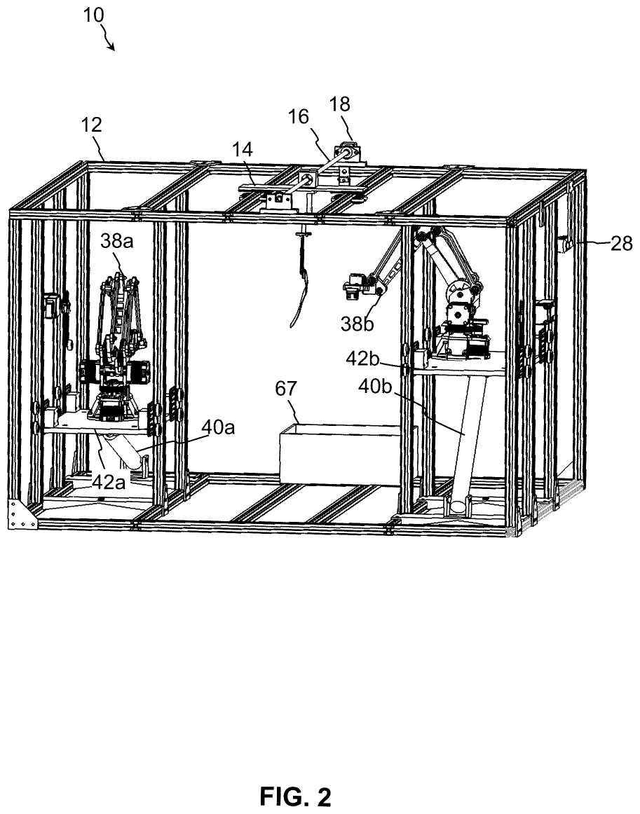

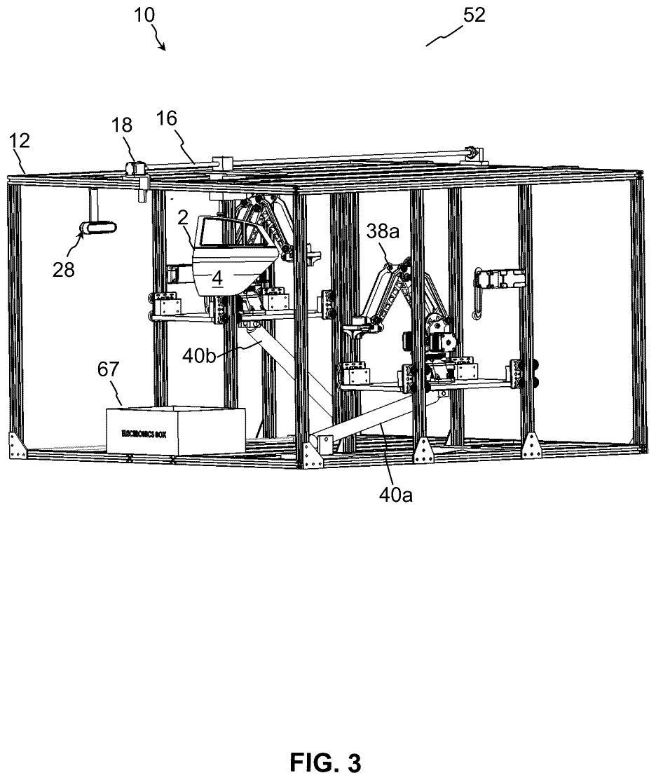

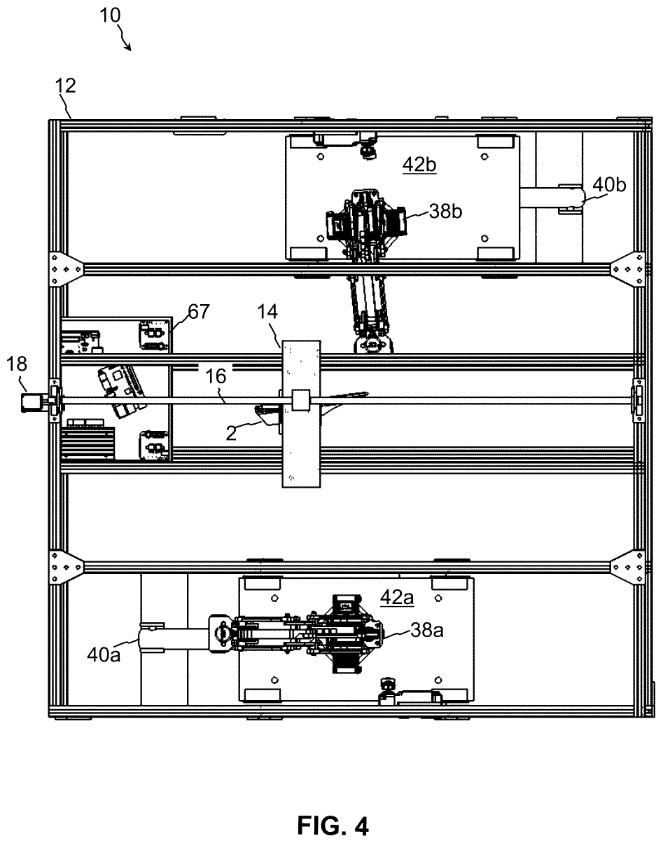

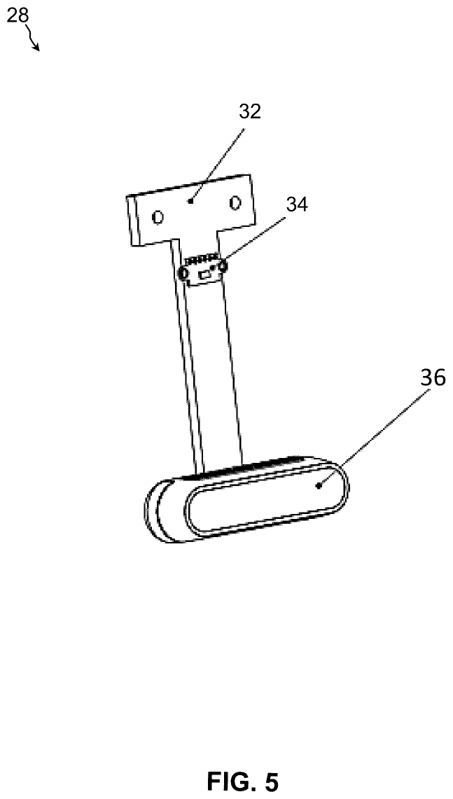

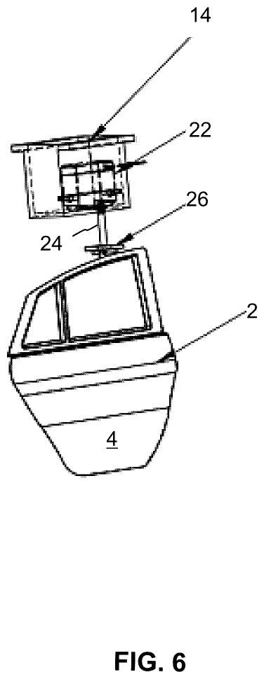

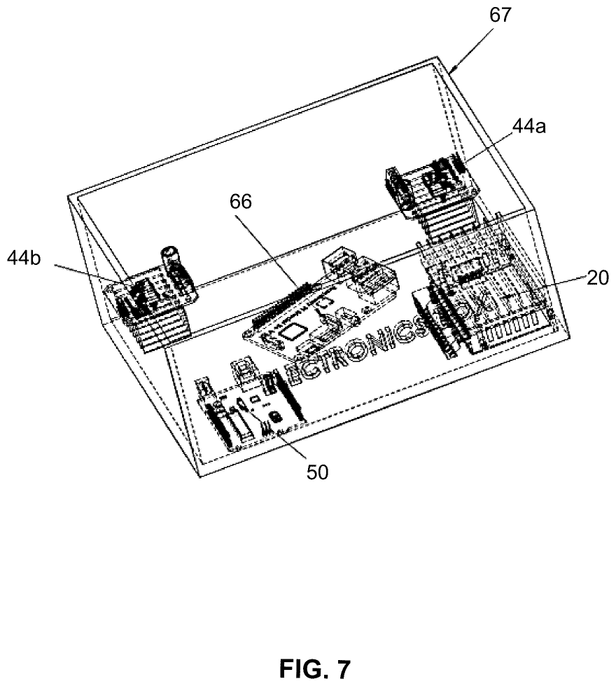

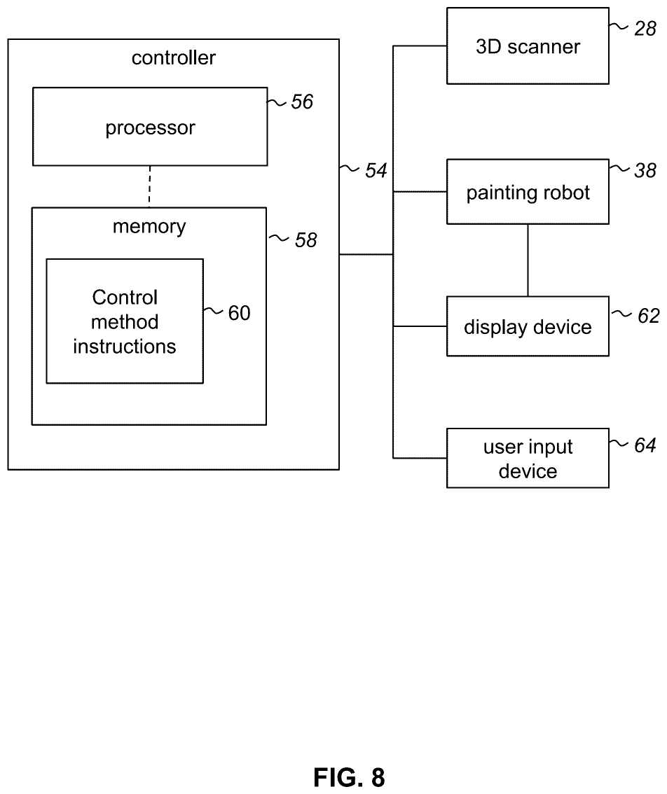

FIGS. 1 to 4 show perspective views (FIGS. 1 to 3) and a top plan view (FIG. 4) of a system 10 for spray painting an object 2 having an object surface 4. The present disclosure is not limited by the nature of the object 2 being painted; as a non-limiting example, the object 2 shown in FIGS. 1, 3 and 4 is a car door. FIG. 5 shows a perspective view of a 3D scanner 28 of the system 10. FIG. 6 shows a perspective view of an object actuator of the system 10. FIG. 7 shows an enclosure 67 containing electronic components of the system 10. FIG. 8 shows a functional block diagram of certain components of the system 10 with lines between the components indicating operative connections, which may be implemented by wired connection protocols (e.g. USB, Ethernet, etc.) and/or wireless connection protocols (e.g., WiFi™, Bluetooth™, etc.) as known in the art. In general, the embodiment of the system 10 include at least one support structure 12, an object actuator, a 3D scanner 28, a painting robot 38, a controller 54 including a processor 56 and a memory 58, a display device 62, and a user input device 64. These and other components of the system 10 are described below.

### Support Structure.

In the embodiment shown, the support structure 12 supports the object 2, the 3D scanner 28, and the painting robot 38. In different embodiments, the support structure 12 may include a plurality of separate support structures, may be constructed in a variety of ways, and may have different configurations, having regard to considerations including the dimensions and weight of the object 2, the 3D scanner 28 and the painting robot 38. In the embodiment shown, the support structure 12 consists of elongate aluminium members bolted together to form a substantially rectangular prismatic frame structure with a rectangular floor frame and a rectangular top frame joined together by horizontally spaced-apart, vertically extending studs.

### Object Actuator.

The object actuator moves the object 2 relative to the 3D scanner 28 to facilitate the 3D scanner 28 scanning the entire object surface 4 of the object 2. The object actuator also moves the object 2 relative to the painting robot 38 to facilitate painting by the painting robot 38 of the object surface 4. The object actuator may be implemented by one or more electromechanical devices that impart motion to the object 2.

In the embodiment shown in the Figures, the object actuator comprises two object actuator mechanisms: an object linear actuator; and an object rotary actuator. The object linear actuator translates the object 2 horizontally from the rear to the front of the support structure 12 and vice versa, so that the object 2 can be positioned for scanning by the 3D scanner 28 and painting by the painting robot 38. In the embodiment shown in the Figures, the object linear actuator includes a carrier member 14, a leadscrew 16 attached to the carrier member 14, a stepper motor 18 (see FIG. 1), and a stepper motor driver 20 (see FIG. 7). The carrier member 14 is slidably attached to the top frame of the support structure 12 by rollers. Under control of the stepper motor driver 20, the stepper motor 18 rotates the leadscrew 16 to slide (translate) the attached carrier member 14 horizontally relative to the support structure 12. A time-of-flight (TOF) distance sensor (e.g., VL53L0X™ time-of-flight laser-ranging module; STMicroelectronics; Geneva, Switzerland) (not shown) is used to monitor the horizontal position of the carrier member 14 in real time.

The object rotary actuator rotates the object 2 about a vertical axis so that the entire object surface 4 can be exposed to the 3D scanner 28. Referring to FIG. 6, the object rotary actuator includes a servo motor 22 attached to the carrier member 14. The servo motor 22 has a spindle 24 terminating in a clamp 26 to attach the object 2 to the spindle 24. The servo motor 22 rotates the spindle 24 and the attached object 2 to rotate the object 2 about a vertical axis relative to the support structure 12.

### 3D Scanner.

The 3D scanner 28 scans the object surface 4 to generate a point cloud model of the object surface 4. “Point cloud model”, as used herein, refers to a set of data points, each defined by positional coordinates, and collectively representing the 3D shape of the object surface 4. The 3D scanner 28 be implemented by a variety of known technologies, with non-limiting embodiments including time-of-flight depth sensing cameras, and LiDAR (laser imaging, detection, and ranging) sensors, and structured-light 3D scanners. For completeness, depth sensing cameras and LiDAR sensors generally include an emitter (e.g., a diode) and a photodetector (e.g., a solid state photodetector). To scan an object 2, a processor (e.g., the processor 56 of the controller 54 discussed below, or a dedicated processor) actuates the emitter to target electromagnetic radiation (e.g., ultraviolet, visible or near infrared light) on the object surface 4, the photodetector senses light or other radiation reflected off of the object surface 4, the processor measures the “time-of-flight” (TOF) for the reflected radiation to return to the photodetector, and computes the distance to the object surface 4 based on the TOF. This scanning process may be performed while the object actuator moves the object 2 relative to the emitter so that the entire object surface 4 can be scanned.

As a non-limiting example, FIG. 5 shows an embodiment of a 3D scanner. The 3D scanner includes a bracket 32 with an attached time-of-flight (TOF) distance sensor 34 (e.g., VL53L0X™ time-of-flight laser-ranging module; STMicroelectronics; Geneva, Switzerland) and a depth camera 36 (e.g., Intel™ RealSense™ D435 depth camera; Intel Corporation) equipped with an infrared radiation (IR) projector and a pair of image sensors. As shown in FIG. 1, the bracket 32 is attached to the top frame of the support structure 12. The TOF distance sensor 34 is used to determine a real-time position of the axis of rotation of the object 2. The depth camera 36 is used to generate the point cloud model of the object surface 4.

### Painting Robot.

“Painting robot”, as used herein, refers to an electromechanical machine including an end effector adapted to hold or comprising a paint spray gun, and actuatable by one or more actuators (e.g., electronic, hydraulic, pneumatic actuators) that are controllable by a processor (e.g., the processor 56 of the controller 54 discussed below, or a dedicated processor) to selectively move the paint spray gun in a defined trajectory. Actuation of the painting robot 38 varies a position, an orientation and velocity of the end effector, thus affecting the distance between the paint spray gun and the object surface 4, and the incidence angle of a paint spraying cone discharged by the paint spray gun on the object surface 4. A painting robot 38 may also comprise sensors (e.g., flow rate sensors, pressure sensors) and metering devices (e.g., valves) that are operatively connected to a processor (e.g., the processor 56 of the controller 54 discussed below, or a dedicated processor) to measure and control the rate of paint discharge from the paint spray gun.

In the embodiment shown in the Figures, the painting robots 38a, 38b (generally, 38) are implemented by a pair of robotic arms (e.g., a Jet Max JETSON NANO™ robotic arm; Shenzhen Hiwonder Technology Co., Ltd., Shenzhen, China). Each robotic arm includes a base, a first segment (or link) rotatably mounted on the base, a second segment (or link) pivotably connected to the first segment, and a third segment (or link) pivotably connected to the second segment and including the end effector (e.g., a holder or gripper). That is, the segments are connected in an articulated manner to form a prismatic-rotation-rotation-rotation (PRRR) robotic arm. Motors are provided to drive rotation or pivoting movement of the segments. Each of the painting robots 38 further includes a robot linear actuator 40a, 40b (generally 40) (e.g., a hydraulic or pneumatic cylinder) having a first end pivotably attached to the bottom frame of the support structure 12 and a second end attached to a platform 42a, 42b (generally 42) that supports the base of the robotic arm. The platform 42 is movably attached by rollers to the vertical studs of the support structure 12 to allow for vertical sliding (translation) of the platform 42 and the supported robotic arm relative to the support structure 12 as the robot linear actuator 40 varies in length. High ampere motor controllers 44a, 44b (see FIG. 7) drive expansion and contraction of the robot linear actuators 40a, 40b respectively. Each platform 42 is associated with a time-of-flight (TOF) distance sensor 46 (e.g., VL53L0X™ time-of-flight laser-ranging module; STMicroelectronics; Geneva, Switzerland) attached to a mounting plate 48 beneath the platform (see FIG. 1) to monitor, in real time, the vertical position of the platform. Current sensors (not shown) (e.g., ACS712™ Hall effect-based linear current sensors; Allegro MicroSystems, Inc.; Manchester NH, USA), are operatively connected to the painting robot 38 and to a current sensor microcontroller 50 (see FIG. 7) (e.g., Arduino Uno™ microcontroller board; Arduino corporation; Italy) to monitor the real-time electric power consumption of the painting robot 38. A limit switch 52 (see FIG. 1) is provided for safety to stop the motion of the platform 42 in case of an erroneous signal from the controller 54.

### Controller, Display Device, and User Input Device.

Referring to FIG. 8, the controller 54 includes at least one processor 56 and at least one memory 58. The memory 58 is a non-transitory computer readable medium that stores instructions for that are executable by the processor 56 to control the 3D scanner 28 and the painting robot 38 in accordance with control method instructions 60 to implement a method of the present disclosure as described below. The memory 58 storing such control method instructions 60 may be considered to be a computer-program product of the present disclosure.

The processor 56 and memory 58 may be operatively connected to a display device 62 for displaying information relating to the control and operation of the 3D scanner 28 and/or painting robot 38. Non-limiting examples of a display device 62 include a computer monitor, or a display screen of a portable computer such as a laptop computer, tablet computer or smartphone. The processor 56 and memory 58 may also be operatively connected to a user input device 64 for a user to provide information relating to the control and operation of the 3D scanner 28 and/or painting robot 38. Non-limiting examples of the user input device 64 include a computer mouse, a computer keyboard, and/or a touch-sensitive display screen.

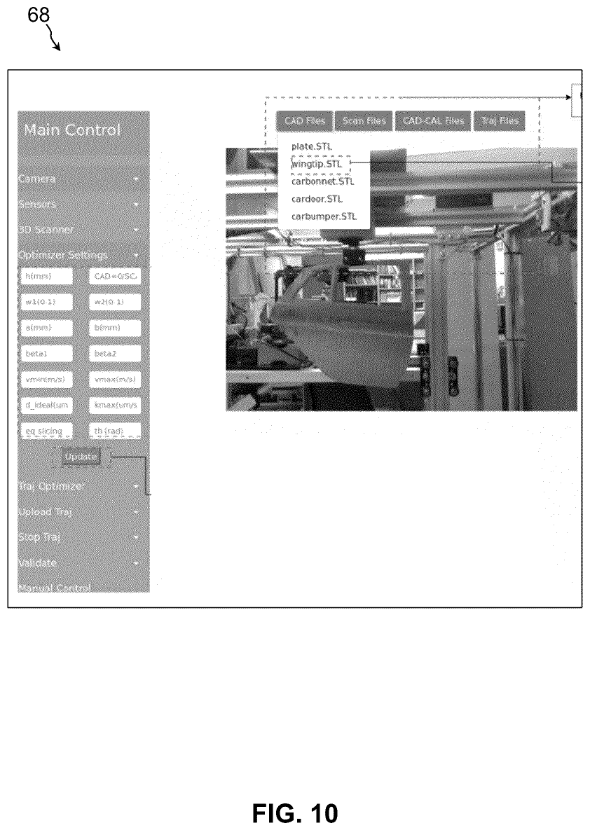

FIG. 8 shows the processor 56 and the memory 58 by single functional blocks, but it will be understood that the processor 56 and the memory 58 may include a plurality of components or sub-components that are operatively connected to each other. For example, each of the processor 56 and the memory 58 may include a plurality of components that are physically discrete and remote from each other, but operatively connected together (e.g., by wire or wireless connections, and/or a communications network or protocols such as Wi-Fi, intranet or Internet protocols) in accordance with distributed computing techniques known in the art. For example, part of the processor 56 and memory 58 may be implemented by a processor and storage media of a server or computer workstation while other parts of the processor 56 and the memory 58 may be implemented by microcontroller units and associated firmware that are physically integrated with other components of the system 10. In the embodiment shown in FIG. 7, for example, the controller 54 may be implemented collectively by microcontroller units associated with the painting robots 38, the stepper motor driver 20, the motor controllers 44, the time-of-flight (TOF) distance sensors 34 and 46, the current sensor microcontroller 50, which are integrated by a microcontroller 66 (e.g., Raspberry Pi™ microcontroller board (Raspberry Pi Ltd.; United Kingdom) linked to a server (e.g., LINUX™ server) (not shown). The foregoing components are contained in an enclosure 67. In one embodiment, for example, the control method instructions 60 are programmed as software in the Python™ programming language (Python Software Foundation) and Robot Operating System 10 (ROS)™ robotics middleware suite. FIG. 10 shows a web-based graphical user interface (GUI) 68 generated by the software that may be implemented using a Hypertext Markup Language (HTML), JavaScript™ programming language, cascading style sheets™ (CSS) language, and WebSocket communications protocols.

### Method for Painting Subroutine for Defining a Spray Gun Trajectory.

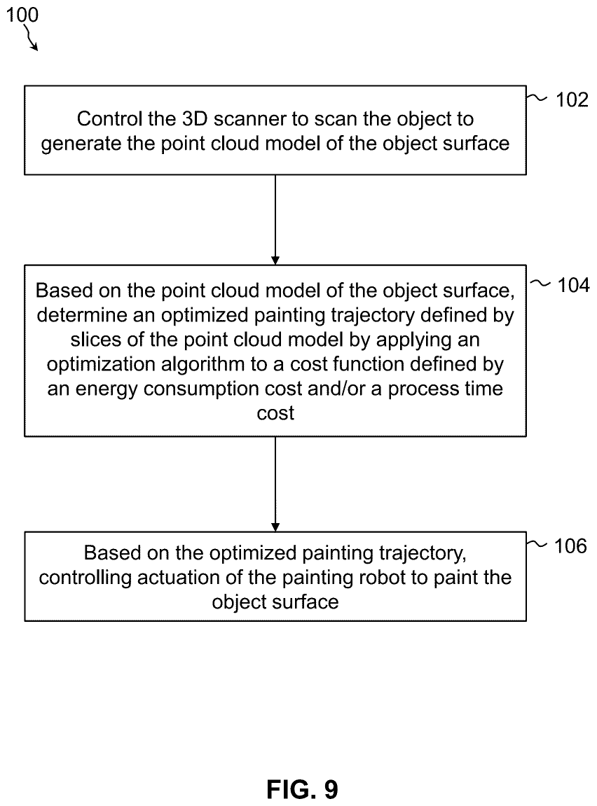

FIG. 9 is a flow chart of an embodiment of a method 100 for spray painting an object 2, as implemented by the system 10 under the control of the controller 54. The method 100 is described below both in general terms, and by way of specific examples. The specific examples utilize models and mathematical formulations, which are provided as non-limiting illustrative examples, and which may be varied without departing from the claimed invention. For example, the models and mathematical formulations may be varied by the person skilled in the art having regard to considerations such as a particular configuration of the painting robot 38, and the paint spray distribution of a particular configuration of a paint spray gun.

### Step 102: Scan Object to Create Point Cloud Model of Object Surface.

At step 102, the controller 54 controls the 3D scanner 28 to scan the object 2 to generate a point cloud model of the object surface 4.

In one embodiment using the system 10 shown in the Figures, the 3D scanner 28 in the form of the depth camera 36 is activated while the servo motor 22 is activated to rotate the object 2 in 30° increments. Red-green-blue (RGB) and depth images are stored for each rotation angle. These images are transformed into point clouds using the camera projection matrix; see: E. R. DAVIES, Machine Vision Theory, Algorithms, Practicalities, Elsevier Inc, 2005, which is incorporated by reference in its entirety herein. A box filter may be applied to the region of interest, to reduce noisy point cloud data. Statistical noise reduction may be applied to for further refinement; see: Q.-Y. Zhou, J. Park and V. Koltun, “Open3D: A Modern Library for 3D Data Processing,” Computer Vision and Pattern Recognition, 2018, which is incorporated by reference in its entirety herein. Raw alignment may be employed to align the 3D scans. Iterative closest point (ICP) registration may be employed to minimize differences between point clouds; see: P. Besl and N. D. Mckay, “A method for registration of 3-d shapes,” IEEE Transactions on Pattern Analysis and Machine Intelligence, vol. 14, no. 2, p. 239-256, February 1992, which is incorporated by reference in its entirety herein. It is within the skill of a person ordinary skill in the art to geometrically align the individual point clouds, geometrically transform them into a common reference frame (e.g., an eigen coordinate system 10), and merge them into a single point cloud model. In embodiments in which the point cloud generated by the 3D scanner 28 has noise or missing parts, it may be supplemented with point cloud data derived from a computer-aided design (CAD) model of the object 2, provided that such point cloud data is also transformed into the same common reference frame. The point cloud data is then used as the point cloud model for determining an optimized painting trajectory for the end effector of the painting robot 38.

### Models.

For the purpose of describing a particular example of the following step of the method 100, it is useful to describe the following exemplary models used in that step.

### Paint Coating Deposition Model.

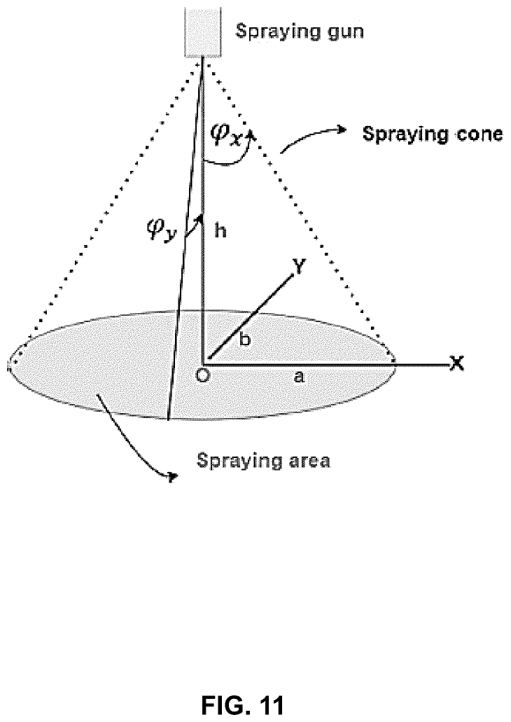

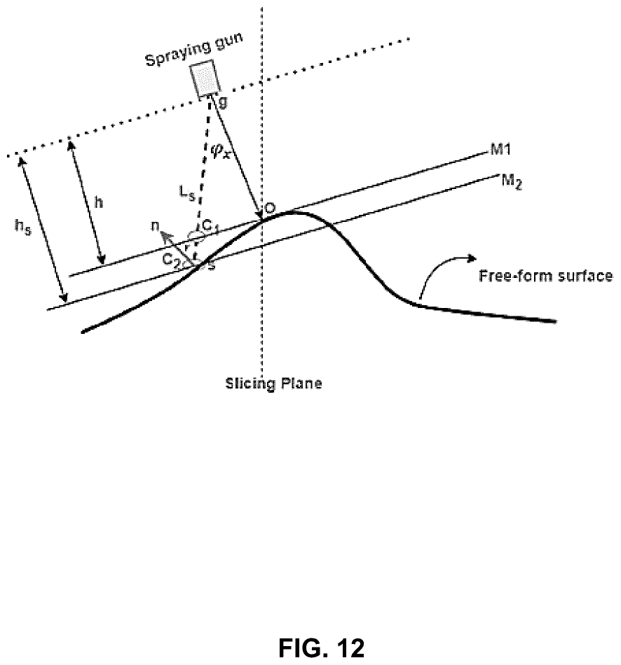

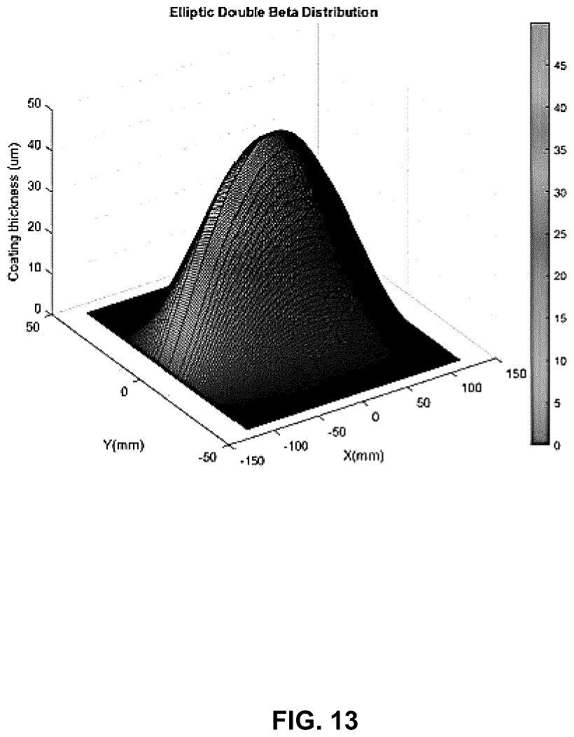

The paint coating deposition model defines how the paint coating thickness is deposited over a complex free-form object surface 4. In one embodiment, an elliptical double beta distribution is used to approximate the paint coating thickness model; see: X. Yu, Z. Cheng, Y. Zhang and L. Ou, “Point cloud modeling and slicing algorithm for trajectory planning of spray painting robot 38,” Robotica, vol. 39, pp. 2246-2267, 2021, which is incorporated by reference in its entirety herein. FIG. 11 shows a geometric model for a paint spray cone emitted by a paint spray gun. The paint area is approximated by an ellipse of length a and b, and opening angles φₓ and φ_{y}. The spread in the X and Y directions are defined by βₓ and β_{y} respectively. FIG. 12 shows a model for static paint coating deposition on an object surface 4. The paint spray gun is assumed to maintain a constant height h from the surface, while hₛ represents the vertical height to point s. The curvature is defined by angle γ, while the maximum coating thickness is dₘₐₓ. The static coating thickness at a point s on a complex free-form surface can be calculated using equation [1]. For a planar surface, with a dₘₐₓ of 50 μm, the elliptical double beta paint coating thickness distribution is shown in FIG. 13.

$${d}_{s} = {{d}_{max} ( 1 - \frac{{x}^{2}}{{a}^{2}} )}^{{β}_{x} - 1} {( 1 - \frac{{y}^{2}}{{b}^{2} ( 1 - \frac{{x}^{2}}{{a}^{2}} )} )}^{{β}_{y} - 1} {( \frac{h}{{h}_{s}} )}^{2} ( \frac{cos γ}{cos {φ}_{x}} ) \qquad [ 1 ]$$

### Painting Robot Dynamic Model.

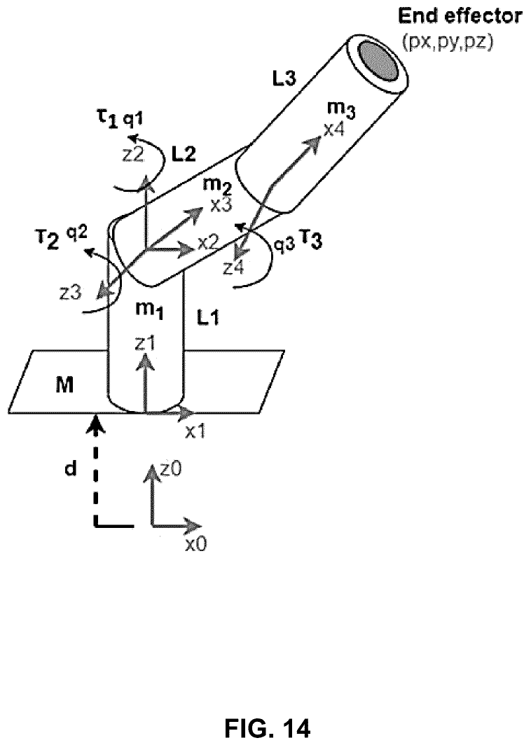

A painting robot dynamic model is used to determine the energy dynamics used in optimizing the painting trajectory. FIG. 14 shows a model for the painting robot 38 shown in the Figures and described above as a PRRR manipulator with an end effector. Table I summarizes its Denavit-Hartenberg (DH) parameters.

TABLE I

| i | αᵢ₋₁ | aᵢ₋₁ | dᵢ | θᵢ |
|---|---|---|---|---|
| 1 | 0 | 0 | d | 0 |
| 2 | 0 | 0 | L₁ | q₁ |
| 3 | 90° | 0 | 0 | q₂ |
| 4 | 0 | L₂ | 0 | q₃ |
| 5 | 0 | L₃ | 0 | 0 |

The end effector position can be calculated by carrying out forward kinematic analysis according to equations [2] to [4].

$${p}_{x} = {c}_{1} ( {L}_{2} {c}_{2} + {L}_{3} {c}_{23} ) \qquad [ 2 ]$$

$${p}_{y} = {s}_{1} ( {L}_{2} {c}_{2} + {L}_{3} {c}_{23} ) \qquad [ 3 ]$$

$${p}_{z} = {L}_{1} + d + {L}_{2} {s}_{2} + {L}_{3} {s}_{23} \qquad [ 4 ]$$

The first prismatic joint is used for extended reach, while the revolute joint angles (q₁, q₂, q₃) are computed using inverse kinematic analysis according to equations [5] to [10].

$${q}_{1} = a tan 2 ( y , x ) \qquad [ 5 ]$$

$${c}_{3} = \frac{{( \frac{x}{{c}_{1}} )}^{2} + {( z - {L}_{1} - d )}^{2} - ( {L}_{2}^{2} + {L}_{3}^{2} )}{2 {L}_{2} {L}_{3}} and {s}_{3} = \pm \sqrt{1 - {c}_{3}^{2}} \qquad [ 6 ]$$

$${q}_{3} = a tan 2 ( {s}_{3} , {c}_{3} ) \qquad [ 7 ]$$

$${c}_{2} = \frac{\vert \begin{matrix}( \frac{x}{{c}_{1}} ) & - {L}_{3} {s}_{3} \\ ( z - {L}_{1} - d ) & {L}_{2} + {L}_{3} {c}_{3}\end{matrix} \vert}{\vert \begin{matrix}{L}_{2} + {L}_{3} {c}_{3} & - {L}_{3} {s}_{3} \\ {L}_{3} {s}_{3} & {L}_{2} + {L}_{3} {c}_{3}\end{matrix} \vert} \qquad [ 8 ]$$

$${s}_{2} = \frac{\vert \begin{matrix}{L}_{2} + {L}_{3} {c}_{3} & ( \frac{x}{{c}_{1}} ) \\ {L}_{3} {s}_{3} & ( z - {L}_{1} - d )\end{matrix} \vert}{\vert \begin{matrix}{L}_{2} + {L}_{3} {c}_{3} & - {L}_{3} {s}_{3} \\ {L}_{3} {s}_{3} & {L}_{2} + {L}_{3} {c}_{3}\end{matrix} \vert} \qquad [ 9 ]$$

$${q}_{2} = a tan 2 ( {s}_{2} , {c}_{2} ) \qquad [ 10 ]$$

The Jacobian matrix in the robot base frame {0} can be used to convert the task space velocity vector to joint space according to equations and [12].

$$\dot{x} = J \dot{q} \qquad [ 11 ]$$

$$J = [ \begin{matrix}0 & - {s}_{1} ( {L}_{2} {c}_{2} + {L}_{3} {c}_{23} ) & - {c}_{1} ( {L}_{2} {s}_{2} + {L}_{3} {s}_{23} ) & - {c}_{1} {L}_{3} {s}_{23} \\ 0 & {c}_{1} ( {L}_{2} {c}_{2} + {L}_{3} {c}_{23} ) & - {s}_{1} ( {L}_{2} {s}_{2} + {L}_{3} {s}_{23} ) & - {s}_{1} {L}_{3} {s}_{23} \\ 1 & 0 & {L}_{2} {c}_{2} + {L}_{3} {c}_{23} & {L}_{3} {c}_{23}\end{matrix} ] \qquad [ 12 ]$$

Finally, the Hessian matrix to convert the task space acceleration to joint space acceleration is obtained by taking the time derivative of Jacobian, according to equation [13].

$$\ddot{x} = J \ddot{q} + H \dot{q} = J \ddot{q} + \dot{J} \dot{q} \qquad [ 13 ]$$

Once the painting robot kinematic model is defined, the dynamic torque can be computed using a RNE (Recursive Newton Euler) approach; see: J. J. Craig, “Manipulator Dynamics,” in Introduction to Robotics Mechanics and Control, Pearson Education International, 2004, pp. 173-176, which is incorporated by reference in its entirety herein. The torque model in joint space is outlined by equation with M (q), C (q, \dot{q}), and G (q, \dot{q}) being the inertia, centrifugal and coriolis, and gravity matrices respectively.

$$τ = M ( q ) \ddot{q} + C ( q , \dot{q} ) \dot{q} + G ( q , \dot{q} ) \qquad [ 14 ]$$

### Paint Spraying Process Model.

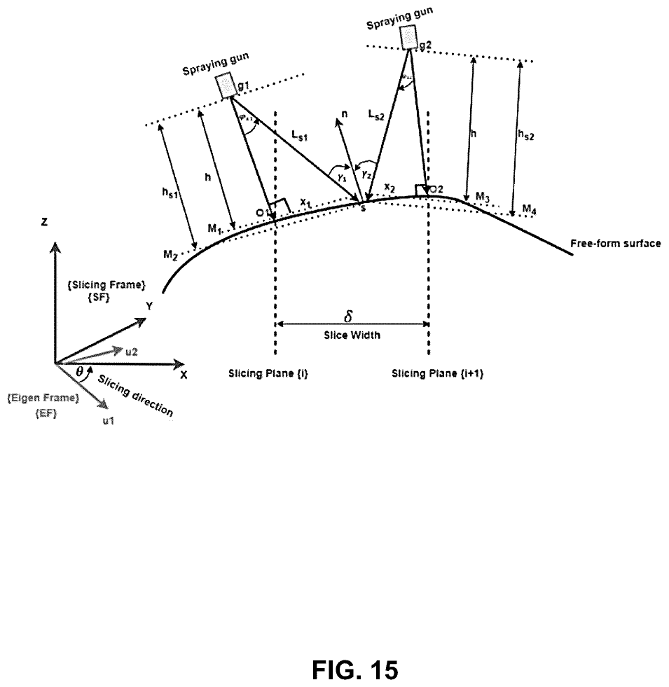

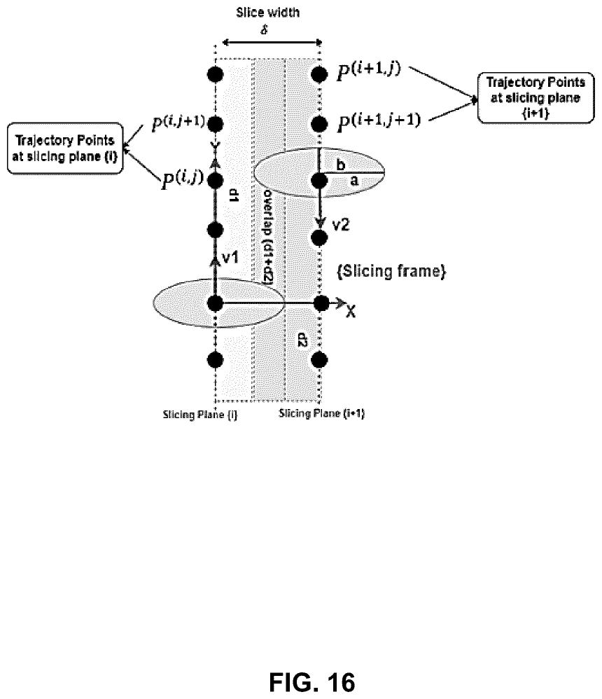

Using the paint coating deposition and the painting robot dynamic model, the spraying process model can be established. Referring to FIG. 15, the point cloud model is sliced at an arbitrary slice angle, θ, with respect to an eigen frame {EF}. The spraying gun moves with a constant speed along the immediate y-axis of the slicing frame {SF} following the curvature of the free-form surface to complete a paint stroke as shown in FIG. 16. A slice is a region of point cloud bounded by two slicing planes i and i+1. The width of the slice is represented by δ, while the speeds of the end effector are ν₁ and ν₂ respectively. In FIG. 15, a vertical line is drawn from the paint spraying gun at the slice plane i to intersect the surface at point O₁. A connection line Lₛ₁ joins the spraying gun with point s making an angle φₓ₁ with the vertical line. Point s has a surface normal n defined by the curvature of the locality while making an angle γ₁ with Lₛ₁. The effective x coordinate of the elliptical paint area is x₁, joining point O₁ and s. In a similar way, these geometric variables are defined for slice i+1. Using the variables defined in FIG. 15, the painting coating thickness function d₍ᵢ₎ at an arbitrary slicing plane i can be presented by equations [15] and [16].

$${f}_{( i )} = {( 1 - \frac{{x}_{( i )}^{2}}{{a}^{2}} )}^{{β}_{x} - 1} {( 1 - \frac{{( {b ( {a}^{2} - {x}_{( i )}^{2} )}^{\frac{1}{2}} - {av}_{( i )} t )}^{2}}{{b}^{2} ( {a}^{2} - {x}_{( i )}^{2} )} )}^{{β}_{y} - 1} \qquad [ 15 ]$$

$${d}_{( i )} = {\int }_{0}^{t ( i )} {k}_{max} {{f}_{( i )} ( \frac{h}{{h}_{s ( i )}} )}^{2} ( \frac{cos {γ}_{( i )}}{cos {φ}_{x ( i )}} ) dt \qquad [ 16 ]$$

The paint coating thickness at point s can be d₁, d₂ or d₁+d₂ subject to the overlap conditions, according to equation [17]. The overlapping conditions are derived by checking the ellipse opening angles, φₓ₁ and φₓ₂, and the angles, γ₁ and γ₂.

$${d}_{s} = \{ \begin{matrix}{d}_{1} if {φ}_{x 1} < {φ}_{x}^{( max )} , {γ}_{1} < 90 ° , {φ}_{x 2} \geq {φ}_{x}^{( max )} or {γ}_{2} \geq 90 ° \\ {d}_{1} + {d}_{2} if {φ}_{x 1} < {φ}_{x}^{( max )} , {γ}_{1} < 90 ° , {φ}_{x 2} < {φ}_{x}^{( max )} and {γ}_{2} < 90 ° \\ {d}_{2} if {φ}_{x 2} < {φ}_{x}^{( max )} , {γ}_{2} < 90 ° , {φ}_{x 1} \geq {φ}_{x}^{( max )} or {γ}_{1} \geq 90 °\end{matrix} \qquad [ 17 ]$$

The individual slices are then sub-divided into patches with each b distance apart along the y-axis of frame {SF}. The trajectory point for a patch is obtained by displacing the mean position along the normal vector of the patch points by h units. Given patch points P_{patch}∈ [symbol] ^{(3,Npatch)} in a portion of slice, and the corresponding trajectory point P^{(I,j)}∈ [symbol] ^{(3,1)}, the Lₛ₍ᵢ₎∈ [symbol] ^{(3,Npatch)} vector for N_{patch} points can be computed using equation [18]:

$$\overline{{L}_{s ( i )}} = {P}_{patch} - {P}^{( i , j )} \qquad [ 18 ]$$

Using dot product between −L̅ₛ̅₍̅ₜ̅₎̅ and n̅, the angle γ₍ᵢ₎∈ [symbol] ^{(1,N}^{_{patch}}⁾ can be computed using equation [19]:

$$cos {γ}_{( i )} = \frac{- \overline{{L}_{s ( i )}} \cdot \overline{n}}{\vert \overline{{L}_{s ( i )}} \vert \vert \overline{n} \vert} \to {γ}_{( i )} = {cos}^{- 1} \frac{- \overline{{L}_{s ( i )}} \cdot \overline{n}}{\vert \overline{{L}_{s ( i )}} \vert \vert \overline{n} \vert} \qquad [ 19 ]$$

Similarly, by taking the dot product of −L̅ₛ̅₍̅ₜ̅₎̅ and h̅, the angle φₓ₍ᵢ₎∈ [symbol] ^{(1, N}^{_{patch}}⁾ can be computed by equation [20].

$$cos {φ}_{x ( i )} = \frac{\overline{{L}_{s ( i )}} \cdot \overline{h}}{\vert \overline{{L}_{s ( i )}} \vert \vert \overline{h} \vert} \to {φ}_{x ( i )} = {cos}^{- 1} \frac{\overline{{L}_{s ( i )}} \cdot \overline{h}}{\vert \overline{{L}_{s ( i )}} \vert \vert \overline{h} \vert} \qquad [ 20 ]$$

Using φₓ₍ᵢ₎, the term φₓ₍ᵢ₎∈ [symbol] ^{(1, N}^{_{patch}}⁾ can be calculated by equation [21].

$${x}_{( i )} = h tan ( {φ}_{x ( i )} ) \qquad [ 21 ]$$

The ratio

$$\frac{h}{{h}_{s ( i )}} ∈ {ℝ}^{( 1 , {N}_{patch} )}$$

can be computed using the law of similar triangles according to the relationship of equation [22]:

$$\frac{h}{{h}_{s ( i )}} = \frac{\sqrt{{x}_{( i )}^{2} + {h}^{2}}}{\vert \overline{{L}_{s ( ι )}} \vert} \qquad [ 22 ]$$

Finally, the time duration t₍ᵢ₎∈ [symbol] ^{(1, N}^{_{patch}}⁾ for each patch point can be found using the relationship of equation [23].

$${t}_{( i )} = \frac{2 b}{{v}_{( i )}} \sqrt{( 1 - \frac{{x}_{( i )}^{2}}{{a}^{2}} )} \qquad [ 23 ]$$

After the computation of these paint coating essential parameters, the paint coating thicknesses are computed using equations 16 and 17. For painting robot dynamic analysis, the velocity vector of the end effector should be defined at each trajectory point. More specifically, given two consecutive trajectory points P^{(i,j)} and P^{(i,j+1)} in the slicing frame {SF} along a paint stroke, the velocity vector at a point j in a slicing plane i is determined by equation [24].

$${\overline{v}}^{( i , j )} = \frac{( {P}^{( i , j + 1 )} - {P}^{( i , j )} )}{‖ {P}^{( i , j + 1 )} - {P}^{( i , j )} ‖} \vert {v}_{( i )} \vert \qquad [ 24 ]$$

The trajectory points and the velocity vector in the robot reference frame can be found using the relative transformations between the slicing frame {SF}, eigen frame {EF}, and the robot base frame {0}, according to equations and [26].

$${P}^{robot} = {}_{SF}^{0} T P = {}_{EF}^{0} T {}_{SF}^{EF} T P \qquad [ 25 ]$$

$${V}^{robot} = {}_{SF}^{0} R V = {}_{EF}^{0} R {}_{SF}^{EF} R V \qquad [ 26 ]$$

The first three rows of matrix P∈ [symbol] ^{(4, Nt)} and V∈ [symbol] ^{(3, N}^{ₜ}⁾ represent the trajectory points (pₓ, p_{y}, p_{z}) and velocity vectors (νₓ, ν_{y}, ν_{z}) respectively. Here, Nₜ represents the total number of trajectory points in a slice. Similarly, the orientation ψ^{(i,j)}∈ [symbol] ^{(3,1)}, of the end effector (i.e., paint spray gun) at a slicing plane i and trajectory point j can be computed by reversing the direction of normal vector that joins point O^{(i,j)} and g^{(i,j)}. The orientation matrix ψ∈ [symbol] ^{(3, N}^{ₜ}⁾ can be transformed into the robot frame using the rotation matrix _{sf}⁰R.

$${ψ}^{( i , j )} = \overline{{n}_{Og}} = \overline{h} \qquad [ 27 ]$$

$${ψ}^{robot} = {}_{SF}^{0} R ψ = {}_{EF}^{- 0} R {}_{SF}^{EF} R ψ \qquad [ 28 ]$$

### Step 104: Determine Optimized Painting Trajectory.

Step 104 involves determining an optimized painting trajectory for the end effector of the painting robot 38. Broadly stated, this involves notionally “slicing” (discretizing) the point cloud model into a plurality of slices that define the optimized painting trajectory. As described above with reference to FIG. 16, a slice is a region of the point cloud model bound by two slicing planes, and defined by a slice angle, θ, a slice width, δ, and a slice speed, ν. The slice angle, θ, is an angle, relative to a reference axis, along which the end effector travels in the painting trajectory. The slice width, δ, is the dimension of the slice in a direction transverse to the slice angle. The slice speed, ν, is the speed at which the end effector moves along the painting trajectory.

For each slice, a cost function comprising at least one cost parameter is computed for each slice. The cost parameter(s) may include an energy consumption cost, J_{E}, which is based on a calculated amount of energy required for the painting robot 38 to move the end effector along the slice. Additionally, or alternatively, the cost parameter(s) may include a process time cost, J_{T}, which is based on a calculated amount of time require for the painting robot 38 to move the end effector along the slice. Additionally, the cost parameter(s) may include a paint thickness deviation cost based on a difference between a paint coating thickness, dₛ, calculated based on the optimized painting trajectory, and a pre-defined desired paint coating thickness, d_{ideal}. Additionally, the cost parameter(s) may include a paint thickness variability cost, based on a standard deviation of a paint coating thickness calculated based on the painting trajectory.

For each of the slices, an optimization algorithm is applied to the cost function to minimize the cost function by varying one or more of the defining parameters of the slices—that is, the slice angle, θ, the slice width, δ, and/or the slice speed, ν. A variety of different optimization algorithms may be used to optimize the multi-variate cost function. A non-limiting type of optimization function is a genetic algorithm (GA). A genetic algorithm is an iterative algorithm creates a “population” of solutions (i.e., the parameters defining the slices), determines a fitness score for the solutions in the population, selects among the potential solutions based on their fitness scores to identify “parents”, modifies or combines the “parents” to produce “children”, and modifies the population of solutions with the “children” and thereby “evolves” the population. The iterative algorithm is repeated until it reaches a constraint condition, with non-limiting examples being a predefined value of the fitness score, a maximum number of “generations”, a maximum run time, or other condition.

In one embodiment, the optimization algorithm may be implemented using a hybrid optimization scheme as follows. The hybrid optimization scheme presents a set of objective functions to achieve coating uniformity, low energy consumption, and process times for the painting trajectory. The end effector trajectory points, orientation, and velocity vectors are converted into joint space using the inverse kinematic and Jacobian defined above. The end effector acceleration is zero since the paint spray gun is moving at a constant speed. It is converted to joint space using the Hessian relationship before RNE is applied to compute link velocities and joint torques. Then, the paint coating thicknesses over slice points are computed using the appropriate relationships.

To achieve a desired paint coating thickness d_{ideal} over a slice, a paint thickness coating deviation cost, Jas, is determined as a mean squared coating error for N pts points in a slice in accordance with equation [29]. The paint thickness coating deviation cost ensures the coating thickness is close to the desired value.

$$\text{?} = \frac{1}{{N}_{pts}} {\sum }_{k = 1}^{{N}_{pts}} {( {d}_{s}^{( k )} - {d}_{ideal} )}^{2} \qquad [ 29 ]$$

$$\text{?} \text{indicates text missing or illegible when filed}$$

To minimize the coating deviation, a paint coating thickness variability cost, J_{derror}, is determined as the ratio of standard deviation and mean of paint coating thicknesses over a slice in accordance with equations [30]-[32]. The paint coating thickness variability cost ensures uniformity of the paint coating thickness.

$${J}_{{d}_{error}} = \frac{{d}_{std}}{{d}_{mean}} \qquad [ 30 ]$$

$${d}_{mean} = \frac{1}{{N}_{pts}} {\sum }_{k = 1}^{{N}_{pts}} {d}_{s}^{( k )} \qquad [ 31 ]$$

$$\text{?} = \sqrt{\frac{{\sum }_{k = 1}^{{N}_{pts}} {( \text{?} - {d}_{mean} )}^{2}}{{N}_{pts}}} \qquad [ 32 ]$$

$$\text{?} \text{indicates text missing or illegible when filed}$$

To minimize the energy consumption of the painting robot 38, the energy consumption cost, J_{E}, is calculated in accordance with equation [33], in which ΔT^{(nt)} represents the time interval between two consecutive trajectory points:

$${J}_{E} = \frac{1}{{N}_{t} - 1} {\sum }_{{n}_{t} = 1}^{{N}_{t} - 1} ( ( {\sum }_{n = 1}^{{N}_{joints}} \frac{1}{2} ( {τ}_{n}^{( {n}_{t} )} {ω}_{n}^{( {n}_{t} )} + {τ}_{n}^{( {n}_{t} + 1 )} {ω}_{n}^{( {n}_{t} + 1 )} ) ) Δ {T}^{( {n}_{t} )} ) \qquad [ 33 ]$$

Finally, to ensure fast trajectories, low velocities can be avoided by a process time cost, determined as an average time between two consecutive trajectory points in accordance with equation [34].

$${J}_{T} = \frac{1}{{N}_{t} - 1} {\sum }_{{n}_{t} = 1}^{{N}_{t} - 1} Δ \text{?} \qquad [ 34 ]$$

$$\text{?} \text{indicates text missing or illegible when filed}$$

The hybrid cost function is determined in accordance with equation [35] as a weighted sum of the four cost parameters defined in equations [29], [30], [33], and [34]. The weighting factors ω₁, ω₂, ω₃, and ω₄ are adjusted to indicate a relative importance of the cost functions. In embodiments, the weighting factors may be entered by the user using the graphical user interface 68 (see FIG. 10). The cost parameters are normalized on a scale of 0 and 1 before computing the total cost function.

$${J}_{tot} = {ω}_{1} {J}_{{d}_{s}}^{norm} + {ω}_{2} {J}_{{d}_{error}}^{norm} + {ω}_{3} {J}_{E}^{norm} + {ω}_{4} {J}_{T}^{norm} \qquad [ 35 ]$$

The fitness function for the genetic algorithm optimizer is then defined as the inverse of the total cost function and by introducing an e term to avoid division by zero, in accordance with equation [36].

$$fitness = \frac{1}{{J}_{tot} + ϵ} \qquad [ 36 ]$$

The constraints for the optimization objective are set out by conditions [37] to [40]:

$$δ ∈ [ \begin{matrix}a & 2 a\end{matrix} ] \qquad [ 37 ]$$

$${v}_{1} , {v}_{2} ∈ [ \begin{matrix}{v}_{min} & {v}_{max} ]\end{matrix} \qquad [ 38 ]$$

$${ik}_{cf} ∈ \{ 0 or 1 \} \qquad [ 39 ]$$

A genetic algorithm (see: S. Mirjalili, “Genetic Algorithm,” in Evolutionary Algorithms and Neural Networks. Studies in Computational Intelligence, Cham, Springer, 2019, which is incorporated by reference in its entirety herein) is then used to optimize the hybrid cost function for a given slice angle (θ), slice width (δ), speeds (ν₁, ν₂), and the inverse kinematic configuration of the painting robot 38 (ik_{cf}).

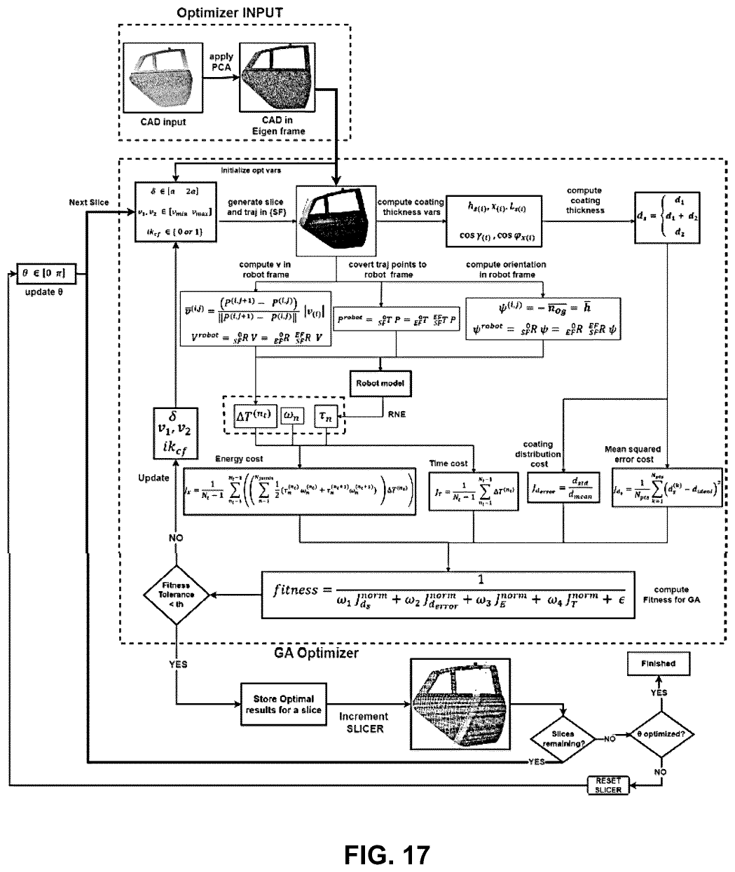

FIG. 17 shows schematic depiction of the hybrid optimization scheme. It will be noted that the painting trajectory is optimized for a given slice angle, θ, on a slice-by-slice basis, until all of the slices are optimized, and then repeated for a different slice angle, θ. The painting trajectories are analyzed based on the four described cost parameters (i.e., paint coating thickness deviation cost; paint coating thickness variability cost; energy consumption cost; and process time cost). The paint coating thickness deviation cost is computed by taking the fractional difference of the mean and desired coating thickness over the entire surface in accordance with equation [41].

$$\text{?} = \frac{\vert {d}_{mean} - {d}_{ideal} \vert}{{d}_{ideal}} \qquad [ 41 ]$$

$$\text{?} \text{indicates text missing or illegible when filed}$$

### Step 106: Controlling Actuation of the Painting Robot.

At step 106, based on the optimized painting trajectory, actuation of the painting robot 38 is controlled to paint the object surface 4. For example, it will be understood that the optimized painting trajectory can be used to determine a corresponding end effector trajectory expressed in terms of position (e.g., x, y, z), an orientation and a velocity vector at a given point in space. The controller 54 can then generate a control signal to actuate the painting robot 38 to move the end effector in accordance with the determined end effector trajectory.

### Example for Painting a Car Door.

The following example demonstrates the method of determining an optimized painting trajectory for painting a car door. The slicing of the point cloud model for the car door was performed using an equidistant slicing scheme (50% overlap), and non-equidistant slicing scheme (variable overlap). The slice angle was discretized into 0°, 30°, 60°, and 90° to save computational resources. Table II below summarizes the model parameters and their values used for this example.

TABLE II

| | | |
|---|---|---|
| Parameter | Description | Value |

Spraying process parameters

| a | Ellipse longer side for the coating model | 15 | mm |
|---|---|---|---|
| b | Ellipse shorter side for the coating model | 5.6 | mm |
| βₓ | Coating distribution beta along the X | 2.3 | |
| | direction of ellipse | | |
| β_{y} | Coating distribution beta along the Y | 4.5 | |
| | direction of ellipse | | |
| kₘₐₓ | Coating deposition rate | 50.0 | μm/s |
| d_{ideal} | Desired coating thickness | 20 | μm |
| vₘᵢₙ | Minimum speed of the spray gun | 3 | mm/s |
| vₘₐₓ | Maximum speed of the spray gun | 15 | mm/s |
| h | Spray gun height from the surface | 10 | mm |

Painting robot model parameters

| | | | |
|---|---|---|---|
| dₛₜᵣₒₖₑ | Link 0 stroke length | 254 | mm |
| L₁ | Manipulator Link 1 length | 92.54 | mm |
| L₂ | Manipulator Link 2 length | 128.4 | mm |
| L₃ | Manipulator Link 3 length | 144.8 | mm |
| M | Manipulator Link 0 mass | 2.5 | kg |
| m₁ | Manipulator Link 1 mass | 0.5 | kg |
| m₂ | Manipulator Link 2 mass | 0.5 | kg |
| m₃ | Manipulator Link 3 mass | 0.5 | kg |

Optimizer Parameters

| ω₁ | Scaling factor for mean squared error | 0.40 |
|---|---|---|
| ω₂ | Scaling factor for coating deviation | 0.20 |
| ω₃ | Scaling factor for mean energy | 0.20 |
| | consumption | |
| ω₄ | Scaling factor for mean trajectory time | 0.20 |
| ϵ | Hyper-parameter in the fitness function | 1.0 |
| rₘ | Mutation rate in genetic algorithm (GA) | 0.1 |
| c_{type} | Crossover type in GA | Two points |
| m_{type} | Mutation type in GA | Random |
| Nₚₐᵣₑₙₜₛ | Number of mating parents in GA | 2 |
| N_{gen} | Number of generations in GA | 25 |
| Nₛₒₗ | Number of solutions per population in | 2 |
| | GA | |

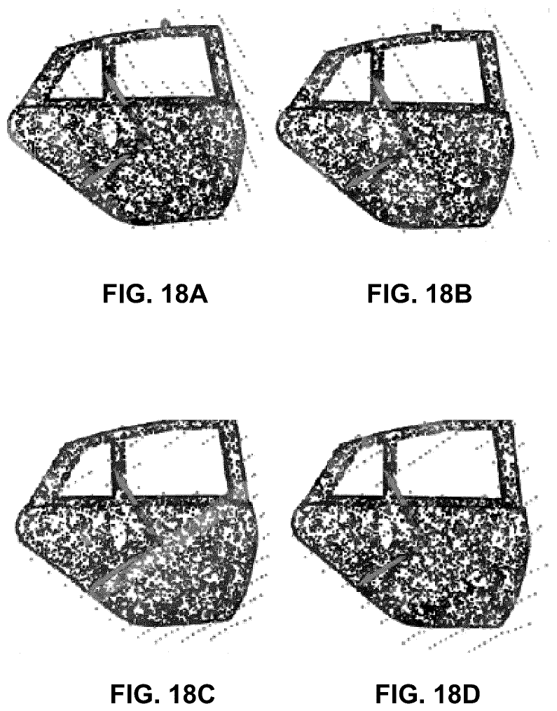

FIGS. 18A to 18D are graphical representations of the determined optimized painting trajectories based on: equidistant point cloud slicing at a slice angle of 0° (FIG. 18A); non-equidistant point cloud sliding at a slice angle of 0° (FIG. 18B); equidistant point cloud slicing at a slice angle of 90° (FIG. 18C); and non-equidistant point cloud slicing at a slice angle of 90° (FIG. 18D).

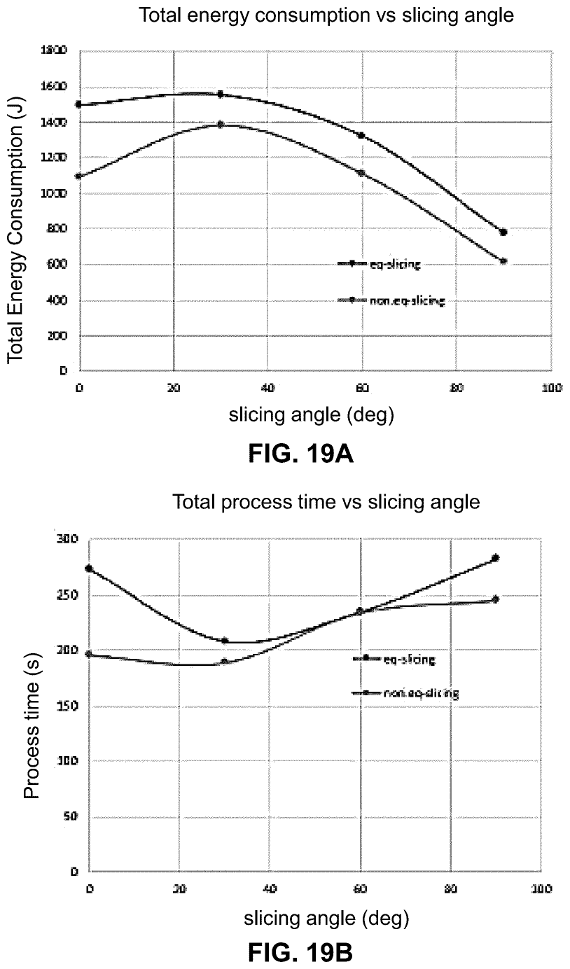

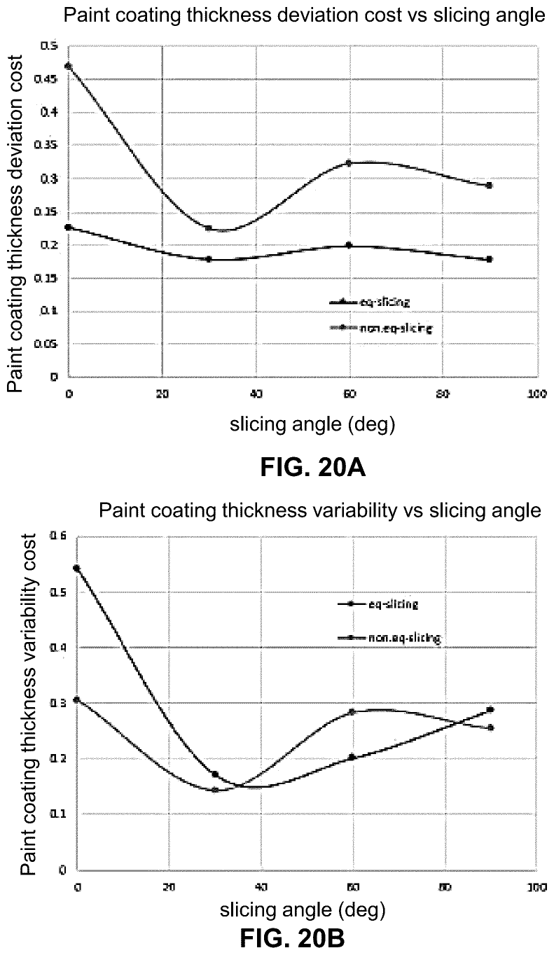

Table III and FIGS. 19A to 20B show results for the optimized painting trajectories for using equidistant slicing and non-equidistant slicing (i.e., non-constant slice width) for different slice angles, θ, of 0°, 30°, 60° and 90°, in terms of the resultant average paint coating thickness, dₘₑₐₙ, total energy cost, Eₛᵤₘ (J) (see FIG. 19A), total process time cost, Tₛᵤₘ, paint coating thickness deviation cost, J_{derror} (see FIG. 20A), and paint coating variability cost, J_{drel} (see FIG. 20B).

TABLE III

| | θ | dₘₑₐₙ (μm) | Eₛᵤₘ (J) | Tₛᵤₘ (s) | J_{derror} | J_{drel} |
|---|---|---|---|---|---|---|
| Equidistant | 0° | 28.58 | 1492.94 | 273.10 | 0.23 | 0.54 |
| slicing | 30° | 19.21 | 1553.09 | 207.76 | 0.18 | 0.17 |
| | 60° | 20.56 | 1320.14 | 234.55 | 0.20 | 0.20 |
| | 90° | 24.12 | 775.75 | 282.17 | 0.18 | 0.29 |
| Non- | 0° | 21.91 | 1092.36 | 195.47 | 0.47 | 0.30 |
| equidistant | 30° | 18.38 | 1382.48 | 188.54 | 0.22 | 0.14 |
| slicing | 60° | 22.91 | 1109.15 | 233.77 | 0.32 | 0.28 |
| | 90° | 23.34 | 611.33 | 244.65 | 0.29 | 0.25 |

This example demonstrates that achieving a desired paint coating thickness depends on spray parameters and robot model. Coating thickness varies due to geometry of the object 2, paint spray gun speed, slice width, and angle. In this example, equidistant slicing results in optimized painting trajectories with lower paint coating thickness error and, for some slice angles, lower paint coating variability error. In this example, non-equidistant slicing results in optimized painting trajectories that are more energy and time efficient, and that cover surfaces with fewer slices. Referring to FIG. 19A, energy efficiency peaks for an optimized painting trajectory with a slice angle of about 90° with non-equidistant slicing, consuming 60% less energy than the least efficient optimized painting trajectory. This is consistent with the configuration of the robot since slicing at smaller angles requires more work against gravity. Referring to FIG. 19B, minimum process time results from an optimized painting trajectory with a slice angle of about 30° with non-equidistant slicing, and is about 33% shorter than the slowest process time. Referring to Table II and FIGS. 20A and 20B, equidistant slicing at about 30° gives an average paint coating thickness (19.21 μm) which is close to the desired paint coating thickness (20 μm), while non-equidistant slicing at the same angle provides the lowest paint coating thickness variability error (about 14%) but a slightly thinner average paint coating thickness (18.38 μm).

### PARTICULAR ASPECTS AND EMBODIMENTS OF THE DISCLOSURE

While the description contained herein constitutes a plurality of embodiments of the present disclosure, it will be appreciated that the present disclosure is susceptible to further modification and change without departing from the fair meaning of the accompanying claims.

Without limiting the generality of the foregoing, the present disclosure includes aspects according to the following examples. It will be understood that any reference to a series of examples is to be understood as a reference to each of those examples disjunctively (e.g., “any one of examples 1 to 4” is to be understood as “examples 1, 2, 3, or 4”; and “any one of the preceding examples” is understood to as a reference to any of the preceding examples individually). Further, it will be understood that features of individual examples of some aspects may be combined with features of individual examples of other aspects. These examples are described solely for purposes of illustration and are not intended to limit the scope of the invention.

Example 1: A system for controlling a 3D scanner and a painting robot to spray paint an object comprising an object surface, the painting robot comprising an end effector adapted to hold or comprising a paint spray gun, the system comprising:
a controller comprising: a processor operatively connected to the 3D scanner and the painting robot; and a memory comprising a non-transitory computer readable medium storing instructions executable by the processor to implement a method comprising:
   controlling the 3D scanner to scan the object to generate the point cloud model of the object surface;
   based on the point cloud model of the object surface, determining an optimized painting trajectory defined by slices of the point cloud model, wherein each of the slices is defined by a slice angle, a slice width, and a slice speed, and wherein determining the optimized painting trajectory comprises applying an optimization algorithm to minimize a cost function defined by at least one cost parameter comprising at least one of:
      an energy consumption cost based on a calculated amount of energy required for the painting robot to move the end effector along the slices; and
      a process time cost based on a calculated amount of time required for the painting robot to move the end effector along the slices; and
   based on the optimized painting trajectory, controlling actuation of the painting robot to paint the object surface.

Example 2: The system of the preceding example, wherein the system further comprises the 3D scanner.

Example 3: The system of any one of the preceding examples, wherein the system further comprises the painting robot.

Example 4: A method for controlling a 3D scanner and a painting robot to spray paint an object comprising an object surface, the painting robot comprising an end effector adapted to hold or comprising a paint spray gun, the method implemented by a processor operatively connected to the 3D scanner and the painting robot, the method comprising:
controlling the 3D scanner to scan the object to generate the point cloud model of the object surface;
based on the point cloud model of the object surface, determining an optimized painting trajectory defined by slices of the point cloud model, wherein each of the slices is defined by a slice angle, a slice width, and a slice speed, and wherein determining the optimized painting trajectory comprises applying an optimization algorithm to minimize a cost function defined by at least one cost parameter comprising at least one of:
   an energy consumption cost based on a calculated amount of energy required for the painting robot to move the end effector along the slices; and
   a process time cost based on a calculated amount of time required for the painting robot to move the end effector along the slices; and
based on the optimized painting trajectory, controlling actuation of the painting robot to paint the object surface.

Example 5: A computer program product comprising a non-transitory computer readable medium storing instructions executable by a processor to implement a method for controlling a 3D scanner and a painting robot to spray paint an object comprising an object surface, wherein the processor is operatively connected to a 3D scanner and the painting robot, wherein the painting robot comprises an end effector adapted to hold or comprising a paint spray gun, the method comprising:
controlling the 3D scanner to scan the object to generate the point cloud model of the object surface;
based on the point cloud model of the object surface, determining an optimized painting trajectory defined by slices of the point cloud model, wherein each of the slices is defined by a slice angle, a slice width, and a slice speed, and wherein determining the optimized painting trajectory comprises applying an optimization algorithm to minimize a cost function defined by at least one cost parameter comprising at least one of:
   an energy consumption cost based on a calculated amount of energy required for the painting robot to move the end effector along the slices; and
   a process time cost based on a calculated amount of time required for the painting robot to move the end effector along the slices; and
based on the optimized painting trajectory, controlling actuation of the painting robot to paint the object surface.

Example 6: The system, method or computer program product of any one of the preceding examples, wherein the at least one cost parameter comprises both the energy consumption cost and the process time cost.

Example 7: The system, method or computer program product of any one of the preceding examples, wherein the at least one cost parameter further comprises: a paint coating thickness deviation cost based on a difference between a paint coating thickness calculated based on the slices and a pre-defined desired paint coating thickness.

Example 8: The system, method or computer program product of any one of the preceding examples, wherein the at least one cost parameter further comprises: a paint coating thickness variability cost based on a standard deviation of a paint coating thickness calculated based on the slices.

Example 9: The system, method or computer program product of any one of the preceding examples, wherein the at least one cost parameter comprises a plurality of cost parameters, and wherein the cost function is further defined by a plurality of weighting factors, wherein each one of the weighting factors is applied to a respective one of the cost parameters.

Example 10: The system, method or computer program product of the preceding example, wherein: the method further comprises: displaying, on a display device, a graphical user interface allowing for user input of the weighting factors.

Example 11: The system, method or computer program product of any one of the preceding examples, wherein the optimization algorithm comprises a genetic algorithm.

Example 12: The system, method or computer program product of any one of the preceding examples, wherein the slices of the optimized painting trajectory have equal widths.

Example 13: The system, method or computer program product of any one of the preceding examples, wherein the slices of the optimized painting trajectory have unequal widths.

Example 14: The system, method or computer program product of any one of the preceding examples, wherein the painting robot comprises a plurality of painting robots.

Although preferred embodiments of the invention have been described herein in detail, it will be understood by those skilled in the art that variations may be made thereto without departing from the spirit of the invention or the scope of the appended claims.

### PARTS LIST

2 object
4 object surface
10 system
12 support structure
14 object linear actuator: carrier member
16 object linear actuator: leadscrew
18 object linear actuator: stepper motor
20 object linear actuator: stepper motor driver
22 object rotary actuator: servo motor
24 object rotary actuator: servo motor spindle
26 object rotary actuator: clamp
28 3D scanner
32 scanner subassembly: bracket
34 scanner subassembly: TOF distance sensor
36 scanner subassembly: depth camera
38a,b painting robot
40a,b painting robot: robot linear actuator
42a,b painting robot: platform
44a,b painting robot: motor controllers
46 painting robot: TOF distance sensor
48 painting robot: mounting plate for TOF distance sensor
50 painting robot: current sensor microcontroller
52 painting robot: limit switch
54 controller
56 controller: processor
58 controller: memory
60 controller: control method instructions
62 display device
64 user input device
66 controller: microcontroller
67 enclosure for controller
68 graphical user interface
100-106 method, and steps thereof

What is claimed is:

1. A system for controlling a 3D scanner and a painting robot to spray paint an object comprising an object surface, the painting robot comprising an end effector adapted to hold or comprising a paint spray gun, the system comprising:
a controller comprising: a processor operatively connected to the 3D scanner and the painting robot; and a memory comprising a non-transitory computer readable medium storing instructions executable by the processor to implement a method comprising:
controlling the 3D scanner to scan the object to generate the point cloud model of the object surface;
based on the point cloud model of the object surface, determining an optimized painting trajectory defined by slices of the point cloud model, wherein each of the slices is defined by a slice angle, a slice width, and a slice speed, and wherein determining the optimized painting trajectory comprises applying an optimization algorithm to minimize a cost function defined by at least one cost parameter comprising at least one of:
an energy consumption cost based on a calculated amount of energy required for the painting robot to move the end effector along the slices; and
a process time cost based on a calculated amount of time required for the painting robot to move the end effector along the slices; and
based on the optimized painting trajectory, controlling actuation of the painting robot to paint the object surface.

2. The system of claim 1, wherein the at least one cost parameter comprises both the energy consumption cost and the process time cost.

3. The system of claim 1, wherein the at least one cost parameter further comprises: a paint coating thickness deviation cost based on a difference between a paint coating thickness calculated based on the slices and a pre-defined desired paint coating thickness.

4. The system of claim 1, wherein the at least one cost parameter further comprises: a paint coating thickness variability cost based on a standard deviation of a paint coating thickness calculated based on the slices.

5. The system of claim 1, wherein the at least one cost parameter comprises a plurality of cost parameters, and wherein the cost function is further defined by a plurality of weighting factors, wherein each one of the weighting factors is applied to a respective one of the cost parameters.

6. The system of claim 1, wherein the optimization algorithm comprises a genetic algorithm.

7. The system of claim 1, wherein the slices of the optimized painting trajectory have unequal widths.

8. A method for controlling a 3D scanner and a painting robot to spray paint an object comprising an object surface, the painting robot comprising an end effector adapted to hold or comprising a paint spray gun, the method implemented by a processor operatively connected to the 3D scanner and the painting robot, the method comprising:
controlling the 3D scanner to scan the object to generate the point cloud model of the object surface;
based on the point cloud model of the object surface, determining an optimized painting trajectory defined by slices of the point cloud model, wherein each of the slices is defined by a slice angle, a slice width, and a slice speed, and wherein determining the optimized painting trajectory comprises applying an optimization algorithm to minimize a cost function defined by at least one cost parameter comprising at least one of:
an energy consumption cost based on a calculated amount of energy required for the painting robot to move the end effector along the slices; and
a process time cost based on a calculated amount of time required for the painting robot to move the end effector along the slices; and
based on the optimized painting trajectory, controlling actuation of the painting robot to paint the object surface.

9. The method of claim 8, wherein the at least one cost parameter comprises both the energy consumption cost and the process time cost.

10. The method of claim 8, wherein the at least one cost parameter further comprises: a paint coating thickness deviation cost based on a difference between a paint coating thickness calculated based on the slices and a pre-defined desired paint coating thickness.

11. The method of claim 8, wherein the at least one cost parameter further comprises: a paint coating thickness variability cost based on a standard deviation of a paint coating thickness calculated based on the slices.

12. The method of claim 8, wherein the at least one cost parameter comprises a plurality of cost parameters, and wherein the cost function is further defined by a plurality of weighting factors, wherein each one of the weighting factors is applied to a respective one of the cost parameters.

13. The method of claim 8, wherein the optimization algorithm comprises a genetic algorithm.

14. The method of claim 8, wherein the slices of the optimized painting trajectory have unequal widths.

15. A computer program product comprising a non-transitory computer readable medium storing instructions executable by a processor to implement a method for controlling a 3D scanner and a painting robot to spray paint an object comprising an object surface, wherein the processor is operatively connected to a 3D scanner and the painting robot, wherein the painting robot comprises an end effector adapted to hold or comprising a paint spray gun, the method comprising:
controlling the 3D scanner to scan the object to generate the point cloud model of the object surface;
based on the point cloud model of the object surface, determining an optimized painting trajectory defined by slices of the point cloud model, wherein each of the slices is defined by a slice angle, a slice width, and a slice speed, and wherein determining the optimized painting trajectory comprises applying an optimization algorithm to minimize a cost function defined by at least one cost parameter comprising at least one of:
an energy consumption cost based on a calculated amount of energy required for the painting robot to move the end effector along the slices; and
a process time cost based on a calculated amount of time required for the painting robot to move the end effector along the slices; and
based on the optimized painting trajectory, controlling actuation of the painting robot to paint the object surface.

16. The computer program product of claim 15, wherein the at least one cost parameter comprises both the energy consumption cost and the process time cost.

17. The computer program product of claim 15, wherein the at least one cost parameter further comprises: a paint coating thickness deviation cost based on a difference between a paint coating thickness calculated based on the slices and a pre-defined desired paint coating thickness.

18. The computer program product of claim 15, wherein the at least one cost parameter further comprises: a paint coating thickness variability cost based on a standard deviation of a paint coating thickness calculated based on the slices.

19. The computer program product of claim 15, wherein the at least one cost parameter comprises a plurality of cost parameters, and wherein the cost function is further defined by a plurality of weighting factors, wherein each one of the weighting factors is applied to a respective one of the cost parameters.

20. The computer program product of claim 15, wherein the slices of the optimized painting trajectory have unequal widths.
